(19) United States
(12) Patent Application Publication
(10) Pub. No.: US 2022/0010218 A1
(43) Pub. Date: Jan. 13, 2022

(54) HIGH-TEMPERATURE PYROLYSIS OF PLASTICS TO MONOMERS WITH HIGH GAS VELOCITY

(71) Applicant: UOP LLC, Des Plaines, IL (US)

(72) Inventor: Lev Davydov, Northbrook, IL (US)

(21) Appl. No.: 17/365,546

(22) Filed: Jul. 1, 2021

Related U.S. Application Data
(60) Provisional application No. 63/050,789, filed on Jul. 11, 2020.

(51) Int. Cl. C10G 1/10

(52) U.S. Cl. CPC C10G 1/10; C10G 2300/1003; C10G 2400/30; C10G 2400/22; C10G 2400/20

(57) ABSTRACT

A high-temperature plastic pyrolysis process that can produce high yields of ethylene, propylene and other light olefins from waste plastics is disclosed. The plastic feed is pyrolyzed at a high temperature of about 600 to about 900° C. directly to monomers, such as ethylene and propylene. The pyrolysis reaction can be conducted in a fluidized manner which requires separation of heat carrier particles from pyrolysis gases.

### CROSS-REFERENCE TO RELATED APPLICATIONS

This application claims priority from U.S. Provisional Application No. 63/050789, filed Jul. 11, 2020, which is incorporated herein in its entirety.

### FIELD

The field is the recycling of plastic materials to produce monomers.

### BACKGROUND

The recovery and recycle of waste plastics is held with deep interest by the general public which has been participating in the front end of the process for decades. Past plastic recycling paradigms can be described as mechanical recycling. Mechanical recycling entails sorting, washing and melting recyclable plastic articles to molten plastic materials to be remolded into a new clean article. However, this mechanical recycling process has not proven economical. The melt and remolding paradigm has encountered several limitations, including economic and qualitative. Collection of recyclable plastic articles at materials recovery facilities inevitably includes non-plastic articles that had to be separated from the recyclable plastic articles. Similarly, collected articles of different plastics have to be separated from each other before undergoing melting because the articles molded of different plastics would not typically have the quality of an article molded of the same plastic. Separation of collected plastic articles from non-plastic articles and then into the same plastics added expense to the process that made it less economical. Additionally, recyclable plastic articles have to be properly cleaned to remove non-plastic residues before melting and remolding which also added to the expense of the process. The recovered plastic also does not possess the quality of virgin grade resins. The burdensome economics of the plastic recycling process and the lower quality of recycled plastic have prevented widespread renewal of this renewable resource.

A paradigm shift has enabled the chemical industry to rapidly respond with new chemical recycling processes for recycling waste plastics. The new paradigm is to chemically convert the recyclable plastics in a pyrolysis process operated at about 350 to 600° C. to liquids. The liquids can be refined in a refinery to fuels, petrochemicals and even monomers that can be re-polymerized to make virgin plastic resins. The pyrolysis process still requires separation of collected non-plastic materials from plastic materials fed to the process, but cleaning and perhaps sorting of plastic materials may not be as critical in chemical recycling.

Higher temperature pyrolysis is under investigation and is viewed as a route to convert plastics directly to monomers without further refining. Conversion of plastics back to monomers presents a circular way of recycling a renewable resource that as of yet has not been fully economically developed. What is needed is a viable process to convert plastic articles directly back to monomers.

### BRIEF SUMMARY

This disclosure describes a high-temperature plastic pyrolysis process that can produce high yields of ethylene, propylene and other light olefins from waste plastics. The plastic feed is pyrolyzed at a high temperature of about 600 to about 1100° C. directly to monomers, such as ethylene and propylene. The pyrolysis reaction can be conducted in a fluidized manner which requires separation of heat carrier particles from pyrolysis gases.

### BRIEF DESCRIPTION OF THE DRAWINGS

FIG. 1 is a schematic drawing of a process and apparatus of the present disclosure.

### DEFINITIONS

The term “communication” means that fluid flow is operatively permitted between enumerated components, which may be characterized as “fluid communication”.

The term “downstream communication” means that at least a portion of fluid flowing to the subject in downstream communication may operatively flow from the object with which it fluidly communicates.

The term “upstream communication” means that at least a portion of the fluid flowing from the subject in upstream communication may operatively flow to the object with which it fluidly communicates.

The term “direct communication” means that fluid flow from the upstream component enters the downstream component without passing through any other intervening vessel.

The term “indirect communication” means that fluid flow from the upstream component enters the downstream component after passing through an intervening vessel.

The term “bypass” means that the object is out of downstream communication with a bypassing subject at least to the extent of bypassing.

The term “predominant”, “predominance” or “predominate” means greater than 50%, suitably greater than 75% and preferably greater than 90%.

The term “carbon-to-gas mole ratio” means the ratio of mole rate of carbon atoms in the plastic feed stream to the mole rate of gas in the diluent gas stream. For a batch process, the carbon-to-gas mole ratio is the ratio of moles of carbon atoms in the plastic in the reactor to the moles of gas added to the reactor.

### DETAILED DESCRIPTION

We have discovered a process a high-temperature plastic pyrolysis process that operates at about 600 to about 1100° C. that can directly convert plastic to C2-C4 olefinic monomers. Testing data has shown high yield of the product monomers. This processing route bypasses the numerous refinery units that would be needed to convert low-temperature plastics pyrolysis oil into monomer products. This processing route also is superior to mechanical recycling because the monomers can be re-polymerized to plastics that are equivalent to virgin-grade material, which mechanical recycling cannot achieve.

The plastic feed can comprise polyolefins such as polyethylene and polypropylene. Any type of polyolefin plastic is acceptable even if mixed with other monomers randomly or as a block copolymer. Hence, a wider range of plastics may be recycled according to this process. We have also found that the plastics feed can be mixed polyolefins. Polyethylene, polypropylene and polybutylene can be mixed together. Additionally, other polymers can be mixed with the polyolefin plastics or provided as feed by itself. Other polymers that can be used by itself or with other polymers include polyethylene terephthalate, polyvinyl chloride, polystyrene, polyamides, acrylonitrile butadiene styrene, polyurethane and polysulfone. Many different plastics can be used in the feed because the process pyrolyzes the plastic feed to smaller molecules including light olefins. The plastic feed stream may contain non-plastic impurities such as paper, wood, aluminum foil, some metallic conductive fillers or halogenated or non-halogenated flame retardants.

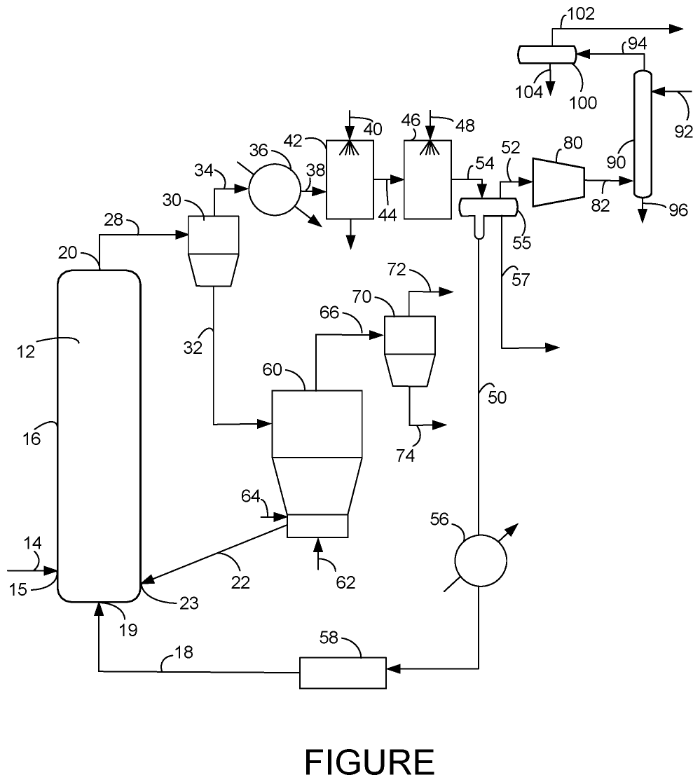

An exemplary plastics pyrolysis process 10 is shown in FIG. 1. A feed to the process is a used plastic perhaps from a materials recovery facility that is fed to a high-temperature pyrolysis reactor (HTPR) 12 in a feed line 14 through a feed inlet 15. The plastic feed may be compressed plastic articles from a separated bail of compacted plastic articles. The plastic articles can be chopped into plastic chips or particles which may be fed to the HTPR 12. An augur or an elevated hopper may be used transport the plastic feed as whole articles or as chips into the reactor. Plastic articles or chips may be heated to above the plastic melting point into a melt and injected or augured into the HTPR 12. An augur may operate in such a way as to move whole plastic articles into the HTPR 12 and simultaneously melt the plastic articles in the augur by friction or by indirect heat exchange into a melt which enters the reactor in a molten state.

The plastic feed injected into the HTPR 12 may be contacted with a diluent gas stream. The diluent gas stream is preferably inert but it may be a hydrocarbon gas. Steam is a preferred diluent gas stream. The diluent gas stream separates reactive olefin products from each other to preserve the selectivity to light olefins thus avoiding oligomerization of light olefins to higher olefins or over cracking to light gas. The diluent gas stream may be provided through a distributor from a diluent line 18 and may be distributed through a diluent inlet 19. The diluent gas stream may be blown into the HTPR 12 through the diluent inlet 19. The diluent inlet 19 may be in a bottom of the HTPR 12. The diluent gas stream may be used to impel plastic feed from the feed inlet 15 of the HTPR 12 to an outlet 20 of the reactor. In an aspect, the feed inlet 15 may be at a lower end of the HTPR 12 and the outlet 20 may be at an upper end of the reactor. The interior of the wall 16 of the HTPR 12 may be coated with refractory lining to insulate the reactor and conserve its heat.

The plastic feed should be heated to a pyrolysis temperature of about 600 to about 1100° C., suitably at least about 800° C. and preferably about 850 to about 950° C. The high-temperature pyrolysis temperature will be much higher than the melting temperature of the plastic at which the plastic may be fed to the HTPR 12. The plastic feed can be preheated to high-temperature pyrolysis temperature before it is fed to the HTPR 12 but is preferably heated to high-temperature pyrolysis temperature after entering the HTPR 12. In an embodiment, the plastic feed is heated to high-temperature pyrolysis temperature by contacting it with a stream of hot heat carrier particles. The stream of hot heat carrier particles may be fed to the reactor in a carrier line 22 through a particle inlet 23. In an aspect, the particle inlet 23 may be located between the diluent inlet 19 and the plastic feed inlet 15. The diluent gas stream will then contact and move the stream of hot heat carrier particles into contact with the plastic feed from feed line 14 through feed inlet 15.

It is contemplated that the stream of heat carrier particles and the plastic feed stream be contacted with each other before entering the HTPR 12, in which case the plastic feed stream and the stream of heat carrier particles may enter the HTPR 12 through the same inlet. It is also contemplated that some or all of the diluent gas stream may impel the heat carrier particles into the reactor in which case the diluent gas stream and the stream of heat carrier particles may enter the HTPR 12 through the same inlet. Additionally, the diluent gas stream may impel the plastic feed into the reactor in which case the diluent gas stream and the plastic feed stream may enter the HTPR 12 through the same inlet. It is also contemplated that the plastic feed stream and the stream of heat carrier particles may be impelled into the HTPR 12 by some or all of the diluent gas stream, in which case at least some of the diluent stream, the plastic feed stream and the stream of heat carrier particles may all enter the HTPR 12 through the same inlet.

It another embodiment, the feed inlet 15 and the particle inlet 23 may be located in an upper end of the reactor from which they can fall together in a downer reactor arrangement (not shown). The diluent gas stream would not function in this embodiment to upwardly fluidize the feed and heat carrier particles.

Upon heating the plastic feed to pyrolysis temperature, the plastic feed vaporizes and pyrolyzes to smaller molecules including light olefins. The vaporization and conversion to a greater number of moles both increase volume causing rapid movement of feed and pyrolysis product toward the reactor outlet 20. Due to the volume expansion of the plastic feed, a diluent gas stream is not necessary to rapidly move feed and product to the outlet. However, diluent gas also serves to separate product olefins from each other and from heat carrier particles to prevent oligomerization and over-cracking which both diminish light olefin selectivity. So, the diluent gas stream may be employed to move the plastic feed stream while undergoing pyrolysis while in contact with the stream of hot heat carrier particles toward the reactor outlet 20. In an aspect, we have found that the diluent gas stream can be introduced at a high carbon-to-gas mole ratio of about 0.6 to about 20. The carbon-to-gas mole ratio may be at least about 0.7, suitably at least about 0.8, more suitably at least about 0.9 and most suitably at least about 1.0. In an aspect, the carbon-to-gas mole ratio may not exceed about 15, suitably may not exceed about 12, more suitably may not exceed about 9 and most suitably may not exceed about 7 and preferably will not exceed about 5. The high carbon-to-gas mole ratio importantly reduces the amount of diluent gas that must be separated from other gases including product gases.

The stream of hot heat carrier particles may be an inert solid particulate such as sand. Additionally, spherical particles may be most easily lifted or fluidized by the diluent gas stream. A spherical alpha alumina may be a preferred material for heat carrier particles. The spherical alpha alumina may be formed by spray drying an alumina solution, followed by calcining it at a temperature that converts the alumina to the α-alumina crystalline phase. In an embodiment, the heat carrier particles should have a smaller average diameter than the plastic articles, chips or melt fed to the reactor. The average diameter of the heat carrier particles refers to the largest average diameter of the particles. The plastic melt may enter the reactor in molten globs that will typically have a larger average diameter than the heat carrier particles.

The plastic feed may be pyrolyzed using various pyrolysis methods including fast pyrolysis and other pyrolysis methods such as vacuum pyrolysis, slow pyrolysis, and others. Fast pyrolysis includes rapidly imparting a relatively high temperature to feedstocks for a very short residence time, typically about 0.5 seconds to about 0.5 minutes, and then rapidly reducing the temperature of the pyrolysis products before chemical equilibrium can occur. By this approach, the structures of the polymers are broken into reactive chemical fragments that are initially formed by depolymerization and volatilization reactions, but do not persist for any significant length of time. Fast pyrolysis is an intense, short duration process that can be carried out in a variety of pyrolysis reactors such as fixed bed pyrolysis reactors, fluidized bed pyrolysis reactors, circulating fluidized bed reactors, or other pyrolysis reactors capable of fast pyrolysis.

The pyrolysis process produces a carbon-containing solid called char, coke that accumulates on the heat carrier particles and pyrolysis gases comprising hydrocarbons including olefins and hydrogen gas.

The heat carrier particles and the plastic feed stream may be fluidized in the reactor by the diluent gas stream. The plastic feed stream and the stream of heat carrier particles may be fluidized by the diluent gas stream continually entering the HTPR 12 through the diluent inlet 19. The heat carrier particles and plastic feed stream can be fluidized in a dense bubbling bed. The molten plastic and heat carrier particles may congeal together into globs until the plastic in the glob fully pyrolyzes to gas. In a bubbling bed, diluent gas stream and vaporized plastic form bubbles that ascend through a discernible top surface of a dense particulate bed. Only heat carrier particles entrained in the gas exits the reactor with the vapor. For a plastic feed that is made into a fluid and fed to the HTPR 12, the superficial velocity of the gas in a bubbling bed is typically less than 3.4 m/s (11.2 ft/s) and the density of the dense bed is typically greater than 475 kg/m³ (49.6 lb/ft³). For a solid plastic feed that is fed as solid particles or fed as a melt to the HTPR 12, such that the plastic feed and heat carrier particles congeal into globs, the superficial velocity for solid plastic feed will be less than 2.7 m/s (9 ft/s) and the density of the bed will be greater than 274 kg/m³ (17.1 lb/ft³). The mixture of heat carrier particles and gas is heterogeneous with pervasive vapor bypassing of catalyst. In the dense bubbling bed, gases will exit the reactor outlet 20; whereas, the solid heat carrier particles and char may exit from a bottom outlet (not shown) of the HTPR 12.

In an aspect, the HTPR 12 may operate in a fast-fluidized flow regime or in a transport or pneumatic conveyance flow regime with a dilute phase of heat carrier particles. The HTPR 12 will operate as a riser reactor. In a fast-fluidized flow and transport flow regime, the stream of globs of heat carrier particles and molten plastic undergoing pyrolysis and gaseous pyrolyzed plastic and the diluent gas stream will flow upwardly together. In both cases, a quasi-dense bed of plastic and heat carrier particle globs will undergo pyrolysis at the bottom of the HTPR 12. The globs of plastic and heat carrier particles will transport upwardly upon sufficient size reduction due to pyrolysis. The diluent gas stream may lift the plastic feed stream and the stream of heat carrier particles. The mixture of gases and the heat carrier particles may be discharged together from the reactor outlet 20 if a separator 30 is located outside of the HTPR 12. If a separator 30 is located in the HTPR 12, the gases will be discharged from the reactor outlet 20 and the heat carrier particles and char will exit from an additional heat carrier particle outlet. Typically, the reactor outlet 20 which discharges the heat carrier particles will be above the heat carrier particle inlet 23. Furthermore, separation of the heat carrier particles from the gaseous products will be conducted above the heat carrier particle inlet 23 and/or the feed inlet 15 in transport and fast-fluidized flow regimes.

The density for a fluid feed in the fast-fluidized flow regime will be between at least about 274 kg/m³ (17.1 lb/ft³) to about 475 kg/m³ (49.6 lb/ft³) and in a transport flow regime will be no more than 274 kg/m3 (17.1 lb/ft³). The density for a plastic feed that congeals into globs in the fast-fluidized flow regime will be between at least about 120 kg/m³ (7.5 lb/ft³) and 274 kg/m³ (17.1 lb/ft³) and in a transport flow regime will be no more than 120 kg/m3 (7.5 lb/ft³). The superficial gas velocity will typically be at least about 2.7 m/s (9 ft/s) to about 8.8 m/s (28.9 ft/s) in a fast-fluidized flow regime for globs of heat carrier particles congealed with plastic. In a transport flow regime, the superficial gas velocity will be at least about 8.8 m/s (28.9 ft/s) for globs of heat carrier particles congealed with plastic. The superficial gas velocity will typically be at least about 3.4 m/s (11.2 ft/s) to about 7.3 m/s (15.8 ft/s) in a fast-fluidized flow regime for fluid plastic feed. In a transport flow regime, the superficial gas velocity will be at least about 7.3 m/s (15.8 ft/s) for fluid plastic feed. The diluent gas stream and product gas ascend in a fast-fluidized flow regime but the hot solids may slip relative to the gas and the gas can take indirect upward trajectories. In a transport flow regime, less of the solids will slip. Residence time for the plastics and product gas in the reactor will about 1 to about 20 seconds and typically no more than 10 seconds.

The reactor effluent comprising heat carrier particles, diluent gas stream and pyrolyzed product gas may exit the HTPR 12 through the reactor outlet 20 in a reactor effluent line 28 and be transported to a separator 30. In an aspect, the separator 30 may be located in the HTPR 12. If the separator 30 is located in the HTPR 12, the heat carrier particles, the diluent gas stream and the pyrolyzed product gas will enter into the separator 30. The reactor effluent in line 28 will be at a temperature of about 600 to about 1100° C. and a pressure of about 1.5 to 2.0 bar (gauge).

The separator 30 may be a cyclonic separator that utilizes centripetal acceleration to separate the heat carrier particles from pyrolyzed gaseous products. The reactor effluent line 28 may tangentially cast reactor effluent into the cyclone separator 30 in a typically horizontally angular trajectory causing the reactor effluent to centripetally accelerate. The centripetal acceleration causes the denser heat carrier particles to gravitate outwardly. The particles lose angular momentum and descend in the cyclone separator 30 into a lower catalyst bed and exit through a heat carrier dip line 32. The less dense gaseous product ascends in the cyclone 30 and are discharged through transfer line 34. In an aspect, pyrolysis gas products may be stripped from heat carrier particles in line 32 by adding a stripping gas to a lower end of the dip line 32. In this embodiment, stripping gas and stripped pyrolysis gases would exit the separator 30 in the transfer line 34.

In an embodiment, a high-temperature pyrolysis product stream in the transfer line 34 may be immediately quenched to prevent and terminate hydrogen transfer reactions and over-cracking which may occur to diminish light olefin selectivity in the high-temperature pyrolysis product stream. Quenching may be effected in the following manner although other quenching processes are contemplated. The high-temperature pyrolysis product stream may be cooled by indirect heat exchange perhaps with water to make steam for the diluent gas stream in a transfer line exchanger 36. The exchanged high-temperature pyrolysis product stream in line 38 may be at a temperature of about 300 to about 400° C. In an aspect, the exchanged high-temperature pyrolysis product stream may be completely quenched by indirect heat exchange with water to produce steam in the transfer line exchanger 36. If the exchanged high-temperature pyrolysis product stream is completely quenched by indirect heat exchange, the completely cooled high-temperature pyrolysis product stream may exit the transfer line exchanger 36 at about 30 to about 60° C. and around atmospheric pressure, 1 to about 1.3 bar (gauge), so lighter components of the vaporous high-temperature pyrolysis product stream can condense.

Alternatively, the exchanged high-temperature pyrolysis product stream in line 38 may be immediately quenched with an oil stream from line 40, such as a fuel oil, in an oil quench chamber 42 to further quench the exchanged high-temperature pyrolysis product stream. The oil stream may be sprayed transversely into the flowing exchanged high-temperature pyrolysis product stream. The exchanged high-temperature pyrolysis product stream remains in the vapor phase while the oil stream exits a bottom of the oil quench chamber 42. The oil stream after exiting the oil quench chamber 42 may be cooled and recycled back to the oil quench chamber. The oil quenched gaseous product stream exits the oil quench chamber in line 44 and may be delivered to a water quench chamber 46 for further quenching. The oil quenched gaseous product stream in line 44 may be immediately quenched with a water stream from line 48 in water quench chamber 46 to further quench the oil quenched gaseous product stream. The water stream may be sprayed transversely into the flowing oil-quenched gaseous product stream. The water quenched gaseous product stream is cooled to about 30 to about 60° C. and around atmospheric pressure, 1 to about 1.3 bar (gauge), so lighter components of the gaseous product stream condense.

In the embodiment in which the transfer line exchanger 36 may comprise one or a series of heat exchangers which indirectly cool the gaseous pyrolysis product stream in the transfer line 34 without direct quench with oil or water, the transfer line 38 will directly connect the transfer line exchanger 36 to the high-temperature pyrolysis separator 55.

The high-temperature pyrolysis product stream in line 54, whether only indirectly quenched in a transfer line heat exchanger 36 or if additionally, directly quenched in quench chambers 42 and 46, is partially condensed due to rapid cooling. The high-temperature pyrolysis product stream is separated in a high-temperature pyrolysis separator 55 to separate a gaseous high-temperature pyrolysis product stream in an overhead line 52 extending from a top of the separator from a liquid high-temperature pyrolysis product stream in a bottoms line 57 extending from a bottom of the separator. The separator 55 may be in downstream communication with the HTPR 12. An aqueous stream in line 50 may be removed from a boot in the high-temperature pyrolysis separator 55 if an aqueous stream is present such as resulting from the water quench chamber 46 in an embodiment. The liquid high-temperature pyrolysis product stream comprising C₅₊ hydrocarbons may be removed from the water quench chamber above the boot in line 57.

The aqueous stream in the water line 50 may be vaporized perhaps by heat exchange in the transfer line exchanger 36 and/or in a water line exchanger 56 and used as the diluent gas stream. A blower 58 blows the steam through the diluent line 19 into the HTPR 12 via the diluent inlet 19.

The gaseous pyrolysis product stream in the overhead line 52 may be compressed in a compressor 80 to about 2 to about 3 MPa (gauge). The compressed gaseous pyrolysis product stream at about 100 to about 150° C. may then be fed to a caustic wash vessel 90 in caustic line 82. In the caustic wash vessel 90, the compressed gaseous product stream is contacted with aqueous sodium hydroxide fed through line 92 into the caustic wash vessel 90 to absorb acid gases such as carbon dioxide into the sodium hydroxide. The carbon dioxide and sodium hydroxide produce sodium carbonate which goes into the aqueous phase and exits in an acid gas rich stream through a caustic bottoms line 96 to be regenerated and recycled. The washed gaseous high-temperature pyrolysis product stream is discharged in a cracked gas line 94 and is fed to a drier 100 to remove residual moisture.

In the drier 100, water is removed from the washed gaseous high-temperature pyrolysis product stream by contacting it with an adsorbent such as a silica gel to adsorb the water or heated to vaporize the water, removing it from the gaseous high-temperature pyrolysis product stream. A water stream is removed in the water line 104 from the drier 100. A dried gaseous high-temperature pyrolysis product stream is recovered in a dried cracked gas line 102

The dried gaseous high-temperature pyrolysis product stream comprises C2, C3 and C4 olefins which can be recovered and used to produce plastics by polymerization. We have found at least 50 wt %, typically at least 60 wt % and suitably at least 70 wt % of the product recovered from gaseous products are valuable ethylene, propylene and butylene products. At lower, more economical carbon-to-diluent gas mole ratios, we have found that at least 40 wt % of the products recovered are valuable light olefins. Recovery of these light olefins represents a circular economy for recycling plastics. A polymerization plant may be on site or the recovered olefins may be transported to a polymerization plant.

Turning back to the separator 30, the heat carrier particles in the heat carrier dip line 32 may have accumulated coke from the pyrolysis process. Moreover, char residue from the pyrolysis process may also end up with the solids in the heat carrier dip line 32. The heat carrier particles have also given off much of their heat in the HTPR 12 and need to be reheated. Therefore, the heat carrier dip line 32 delivers the heat carrier particles and char to the reheater 60.

In aspect, the predominance of heat carrier particles entering the reheater 60 passes through the separator 30. In an embodiment, all of the heat carrier particles entering the reheater 60 passes through the separator 30.

The heat carrier particles and char are fed to the reheater 60 and contacted with an oxygen supply gas in line 62 such as air to combust char and the coke on the cool heat carrier particles. The reheater 60 is a separate vessel from the HTPR 12. The coke is burned off the spent catalyst by contact with the oxygen supply gas at combustion conditions. Heat of combustion serves to reheat the heat carrier particles. About 10 to about 15 kg of air are required per kg of coke burned off of the heat carrier particles. A fuel gas stream in line 64 may also be added to the reheater 60 if necessary, to produce sufficient heat to drive the pyrolysis reaction in the HTPR 12. The fuel gas may be obtained from paraffins recovered from the gaseous high-temperature pyrolysis product stream in line 102. Exemplary reheating conditions include a temperature from about 700° C. to about 1000° C. and a pressure of about 1 to about 5 bar (absolute) in the reheater 60.

A stream of reheated heat carrier particles is recycled to the high-temperature pyrolysis reactor 12 in line 22 through heat carrier particle inlet 23 at a temperature of the reheater 60. Flue gas and entrained char exit the reheater in line 66 and are delivered to a cyclone 70 which separates exhaust gas in an overhead line 72 from a solid ash product in line 74.

### EXAMPLE

We conducted a pyrolysis reaction of HDPE plastic feed at high temperatures. Plastic pellets were dropped through a water-cooled jacketed tube into a heated bed of fluidized alpha-alumina particles to simulate the high-temperature pyrolysis process. Nitrogen gas was used to deliver the plastic pellet to the fluidized bed through the cold tube and to fluidize the bed of heat carrier particles. A nitrogen sweep gas was used to sweep the pyrolyzed plastic gas emitted above the bed around the water-cooled jacket to quench the pyrolysis reaction. Nitrogen sweep gas was not factored into the carbon-to-gas mole ratio calculation since it was not present with the plastic in the fluidized bed during the pyrolysis of the plastic pellet. Gas chromatography was used to determine products of the pyrolysis. The varying pyrolysis conditions and product compositions are shown in the Table.

TABLE

| Run | 10 | 9 | 11 | 12 | 13 | 14 |
|---|---|---|---|---|---|---|
| Reaction | 751 | 801 | 827 | 837 | 878 | 895 |
| Temp., ° C. | | | | | | |
| C/N₂ Mole | 1.8 | 0.9 | 2.7 | 1.2 | 1 | 0.9 |
| Ratio | | | | | | |

Yield, %

| | | | | | | |
|---|---|---|---|---|---|---|
| Hydrogen | 0.70 | 0.71 | 0.95 | 0.95 | 1.02 | 1.41 |
| Methane | 5.09 | 5.21 | 7.24 | 7.21 | 10.21 | 10.66 |
| Ethane | 1.94 | 1.61 | 1.81 | 1.50 | 1.26 | 1.12 |
| Ethylene | 14.28 | 15.54 | 20.22 | 21.04 | 24.71 | 23.16 |
| Propane | 0.48 | 0.48 | 0.42 | 0.31 | 0.18 | 0.00 |
| Propylene | 7.41 | 7.82 | 8.80 | 7.40 | 3.96 | 2.13 |
| MAPD | 0.00 | 0.00 | 0.00 | 0.00 | 0.32 | 0.23 |
| Isobutane | 0.01 | 0.01 | 0.01 | 0.00 | 0.00 | 0.00 |
| n-Butane | 0.00 | 0.00 | 0.00 | 0.00 | 0.15 | 0.12 |
| Butenes and | 7.09 | 7.36 | 6.23 | 5.12 | 2.75 | 1.73 |
| Butadiene | | | | | | |
| Isopentane | 0.17 | 0.18 | 0.08 | 0.05 | 0.02 | 0.00 |
| N-Pentane | 0.07 | 0.06 | 0.03 | 0.02 | 0.10 | 0.05 |
| Pentenes | 5.02 | 4.62 | 3.48 | 2.97 | 1.71 | 1.13 |
| C6-C9 | 17.98 | 13.40 | 4.47 | 2.70 | 0.81 | 0.46 |
| Benzene | 8.70 | 8.13 | 13.07 | 13.92 | 16.03 | 17.24 |
| Toluene | 6.91 | 5.06 | 6.53 | 6.18 | 5.28 | 5.09 |
| Ethylbenzene | 1.38 | 0.93 | 0.95 | 0.74 | 0.27 | 0.18 |
| P + M-Xylene | 1.63 | 1.03 | 1.01 | 0.92 | 0.76 | 0.80 |
| O-Xylene | 1.04 | 0.66 | 0.56 | 0.47 | 0.30 | 0.26 |
| Styrene | 3.21 | 3.07 | 5.71 | 6.46 | 7.32 | 9.59 |
| Coke | 7.29 | 13.49 | 8.16 | 8.77 | 15.14 | 13.12 |
| Heavies | 9.62 | 10.65 | 10.26 | 13.29 | 7.70 | 11.53 |

Approximately 40 wt % of the products comprise C2-C4 olefins which are highly valued. Valuable aromatics production is also substantial.

### SPECIFIC EMBODIMENTS

While the following is described in conjunction with specific embodiments, it will be understood that this description is intended to illustrate and not limit the scope of the preceding description and the appended claims.

A first embodiment of the disclosure is a process for converting plastics to monomers comprising contacting a plastic feed stream with a stream of hot heat carrier particles in a reactor; heating the plastic feed stream to an elevated temperature of about 600 to about 1100° C.; lifting the plastic feed stream and the stream of hot heat carrier particles together; pyrolyzing the plastic in the plastic feed stream to gaseous products including monomers; separating the gaseous products from the heat carrier particles; and recovering the monomers from the gaseous products. An embodiment of the disclosure is one, any or all of prior embodiments in this paragraph up through the first embodiment in this paragraph further comprising lifting the plastic feed stream and the stream of hot heat carrier particles by use of a diluent gas stream. An embodiment of the disclosure is one, any or all of prior embodiments in this paragraph up through the first embodiment in this paragraph further comprising lifting the stream of hot heat carrier particles into the plastic feed stream with the diluent gas stream. An embodiment of the disclosure is one, any or all of prior embodiments in this paragraph up through the first embodiment in this paragraph further comprising feeding the stream of hot heat carrier particles through a heat carrier particle inlet into the reactor and separating the gaseous products from the heat carrier particles above the heat carrier particle inlet. An embodiment of the disclosure is one, any or all of prior embodiments in this paragraph up through the first embodiment in this paragraph wherein the heat carrier particles are spherical. An embodiment of the disclosure is one, any or all of prior embodiments in this paragraph up through the first embodiment in this paragraph further comprising reheating the separated heat carrier particles in a reheater and recycling a stream of the hot heat carrier particles from the reheater to the reactor. An embodiment of the disclosure is one, any or all of prior embodiments in this paragraph up through the first embodiment in this paragraph further comprising combusting fuel gas in the reheater to reheat the hot heat carrier particles. An embodiment of the disclosure is one, any or all of prior embodiments in this paragraph up through the first embodiment in this paragraph further comprising quenching the gaseous products with a cooling liquid to terminate the pyrolysis reaction. An embodiment of the disclosure is one, any or all of prior embodiments in this paragraph up through the first embodiment in this paragraph further comprising discharging the gaseous products and the heat carrier particles from the reactor before separating the gaseous products from the heat carrier particles. An embodiment of the disclosure is one, any or all of prior embodiments in this paragraph up through the first embodiment in this paragraph further comprising separating the gaseous products from the heat carrier particles in a cyclonic separator.

A second embodiment of the disclosure is a process for converting plastics to monomers comprising feeding a stream of hot heat carrier particles to a reactor; feeding a plastic feed stream to the reactor; lifting the hot heat carrier particles with a diluent gas into contact with the plastic feed stream; heating the plastic feed stream to an elevated temperature of about 600 to about 1100° C.; pyrolyzing the plastic in the plastic feed stream to gaseous products including monomers; separating the gaseous products from the heat carrier particles; and recovering the monomers from the gaseous products. An embodiment of the disclosure is one, any or all of prior embodiments in this paragraph up through the second embodiment in this paragraph further comprising lifting the plastic feed stream and the stream of hot heat carrier particles together by use of a diluent gas stream. An embodiment of the disclosure is one, any or all of prior embodiments in this paragraph up through the second embodiment in this paragraph further comprising feeding the stream of hot heat carrier particles through a heat carrier particle inlet into the reactor and separating the gaseous products from the heat carrier particles above the heat carrier particle inlet. An embodiment of the disclosure is one, any or all of prior embodiments in this paragraph up through the second embodiment in this paragraph further comprising reheating the separated heat carrier particles in a reheater and recycling a stream of the hot heat carrier particles from the reheater to the reactor. An embodiment of the disclosure is one, any or all of prior embodiments in this paragraph up through the second embodiment in this paragraph further comprising quenching the gaseous products to terminate the pyrolysis reaction. An embodiment of the disclosure is one, any or all of prior embodiments in this paragraph up through the second embodiment in this paragraph further comprising discharging the gaseous products and the heat carrier particles from the reactor before separating the gaseous products from the heat carrier particles. An embodiment of the disclosure is one, any or all of prior embodiments in this paragraph up through the second embodiment in this paragraph further comprising separating the gaseous products from the heat carrier particles in a cyclonic separator.

A third embodiment of the disclosure is a process for converting plastics to monomers comprising feeding a stream of hot heat carrier particles into a reactor through a particle inlet; contacting a plastic feed stream with a stream of hot heat carrier particles in a reactor; heating the plastic feed stream to an elevated temperature of about 600 to about 1100° C.; pyrolyzing the plastic in the plastic feed stream to gaseous products including monomers; moving the plastic feed stream and the stream of hot heat carrier particles together toward a reactor outlet; separating the gaseous products from the heat carrier particles; and recovering the monomers from the gaseous products. An embodiment of the disclosure is one, any or all of prior embodiments in this paragraph up through the third embodiment in this paragraph wherein the reactor outlet is above the particle inlet. An embodiment of the disclosure is one, any or all of prior embodiments in this paragraph up through the third embodiment in this paragraph further comprising discharging the heat carrier particles and the gaseous products from the reactor outlet; and separating the heat carrier particles from the gaseous products.

Without further elaboration, it is believed that using the preceding description that one skilled in the art can utilize the present disclosure to its fullest extent and easily ascertain the essential characteristics of this disclosure, without departing from the spirit and scope thereof, to make various changes and modifications of the disclosure and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims.

In the foregoing, all temperatures are set forth in degrees Celsius and, all parts and percentages are by weight, unless otherwise indicated.

1. A process for converting plastics to monomers comprising:
contacting a plastic feed stream with a stream of hot heat carrier particles in a reactor;
heating the plastic feed stream to an elevated temperature of about 600 to about 1100° C.;
lifting the plastic feed stream and the stream of hot heat carrier particles together;
pyrolyzing the plastic in the plastic feed stream to gaseous products including monomers;
separating the gaseous products from the heat carrier particles; and
recovering said monomers from said gaseous products.

2. The process of claim 1 further comprising lifting the plastic feed stream and the stream of hot heat carrier particles by use of a diluent gas stream.

3. The process of claim 2 further comprising lifting the stream of hot heat carrier particles into the plastic feed stream with the diluent gas stream.

4. The process of claim 1 further comprising feeding the stream of hot heat carrier particles through a heat carrier particle inlet into the reactor and separating the gaseous products from the heat carrier particles above the heat carrier particle inlet.

5. The process of claim 2 wherein the heat carrier particles are spherical.

6. The process of claim 5 further comprising reheating the separated heat carrier particles in a reheater and recycling a stream of the hot heat carrier particles from the reheater to the reactor.

7. The process of claim 5 further comprising combusting fuel gas in the reheater to reheat the hot heat carrier particles.

8. The process of claim 1 further comprising quenching the gaseous products with a cooling liquid to terminate the pyrolysis reaction.

9. The process of claim 1 further comprising discharging the gaseous products and the heat carrier particles from the reactor before separating the gaseous products from the heat carrier particles.

10. The process of claim 1 further comprising separating said gaseous products from said heat carrier particles in a cyclonic separator.

11. A process for converting plastics to monomers comprising:
feeding a stream of hot heat carrier particles to a reactor;
feeding a plastic feed stream to the reactor;
lifting the hot heat carrier particles with a diluent gas into contact with the plastic feed stream;
heating the plastic feed stream to an elevated temperature of about 600 to about 1100° C.;
pyrolyzing the plastic in the plastic feed stream to gaseous products including monomers;
separating the gaseous products from the heat carrier particles; and
recovering said monomers from said gaseous products.

12. The process of claim 11 further comprising lifting the plastic feed stream and the stream of hot heat carrier particles together by use of a diluent gas stream.

13. The process of claim 11 further comprising feeding the stream of hot heat carrier particles through a heat carrier particle inlet into the reactor and separating the gaseous products from the heat carrier particles above the heat carrier particle inlet.

14. The process of claim 11 further comprising reheating the separated heat carrier particles in a reheater and recycling a stream of the hot heat carrier particles from the reheater to the reactor.

15. The process of claim 11 further comprising quenching the gaseous products to terminate the pyrolysis reaction.

16. The process of claim 1 further comprising discharging the gaseous products and the heat carrier particles from the reactor before separating the gaseous products from the heat carrier particles.

17. The process of claim 1 further comprising separating said gaseous products from said heat carrier particles in a cyclonic separator.

18. A process for converting plastics to monomers comprising:
feeding a stream of hot heat carrier particles into a reactor through a particle inlet;
contacting a plastic feed stream with a stream of hot heat carrier particles in a reactor;
heating the plastic feed stream to an elevated temperature of about 600 to about 1100° C.;
pyrolyzing the plastic in the plastic feed stream to gaseous products including monomers;
moving the plastic feed stream and the stream of hot heat carrier particles together toward a reactor outlet;
separating the gaseous products from the heat carrier particles; and
recovering said monomers from said gaseous products.

19. The process of claim 18 wherein the reactor outlet is above the particle inlet.

20. The process of claim 18 further comprising:
discharging the heat carrier particles and the gaseous products from the reactor outlet; and
separating the heat carrier particles from the gaseous products.
